(19) United States
(12) Patent Application Publication
(10) Pub. No.: US 2025/0258491 A1
(43) Pub. Date: Aug. 14, 2025

(54) METHODS AND APPARATUS TO MONITOR ASSET HEALTH WITH CLOUD TEMPLATES

(71) Applicant: Fisher-Rosemount Systems, Inc., Round Rock, TX (US)

(72) Inventors: Shaobo Qiu, Cedar Park, TX (US); David R. Denison, Austin, TX (US); Manikandan Nambiar, Austin, TX (US); Michael Woytek Tworzydlo, Austin, TX (US)

(21) Appl. No.: 18/436,801

(22) Filed: Feb. 8, 2024

(51) Int. Cl. G05B 23/02

(52) U.S. Cl. CPC G05B 23/0216

(57) ABSTRACT

Systems, apparatus, articles of manufacture, and methods to monitor asset health with cloud templates are disclosed. An example apparatus comprises interface circuitry, machine-readable instructions, and at least one processor circuit to be programmed by the machine-readable instructions to access, via a cloud resource, sensor data associated with a process control device operating in a process control system, compare the sensor data to a threshold parameter associated with the process control device, obtain, from a cloud template deployed in the cloud resource, a health parameter of the process control device based on the comparison, and display the health parameter on a user interface of a computing device, the computing device accessing the cloud resource.

### FIELD OF THE DISCLOSURE

This disclosure relates generally to asset monitoring and, more particularly, to methods and apparatus to monitor asset health with cloud templates.

### BACKGROUND

Process operations, like those used in the oil and gas industry, typically include significant equipment assets, such as pumps, heat exchangers, cooling towers, etc. The condition, health, integrity, and/or performance of such assets are essential to the efficiency and/or safety of processing plants.

### BRIEF DESCRIPTION OF THE DRAWINGS

FIG. 1 is a block diagram of an example environment in which example asset management circuitry operates to provide asset information to an example client device.

FIGS. 2 and 3 illustrate example visualizations of an example user interface associated with the client device in FIG. 1.

FIG. 4 illustrates another example environment in which the asset management circuitry of FIG. 1 operates to provide asset information to an example client.

FIG. 5 illustrates an example data publisher communicatively coupled to a first example customer cloud environment and a second example customer cloud environment.

FIG. 6 is a flowchart representative of example machine readable instructions and/or example operations that may be executed, instantiated, and/or performed by example programmable circuitry to implement the asset management circuitry of FIG. 1.

FIG. 7 is a block diagram of an example processing platform including programmable circuitry structured to execute, instantiate, and/or perform the example machine readable instructions and/or perform the example operations of FIG. 6 to implement the asset management circuitry of FIG. 1.

FIG. 8 is a block diagram of an example implementation of the programmable circuitry of FIG. 7.

In general, the same reference numbers will be used throughout the drawing(s) and accompanying written description to refer to the same or like parts. The figures are not necessarily to scale.

### DETAILED DESCRIPTION

Process control systems are systems that have the ability to monitor and adjust a process or operation in a process control environment (e.g., a factory, a plant, a refinery, etc.) to achieve a desired output. For example, process control systems can utilize a combination of hardware and software to monitor, analyze, and control the variables within an example process. Process control systems are growing increasingly complex as individual components of the process control systems are developed and deployed with increased data acquisition resolution, processing power, and signal conditioning. Process control systems typically contain at least one controller with accompanying inputs and outputs, which allow the controller(s) to control and/or acquire signals from various assets.

As used herein, the terms “asset,” “field device,” and/or “process control device” are used interchangeably and refer to assemblies and/or devices (e.g., computing devices, electronic devices, etc.) such as, for example, actuators, actuator assemblies, actuator controllers, actuator positioners, sensors (e.g., rate and/or speed sensors, level sensors, pressure sensors, temperature sensors, etc.), transmitters, valve assemblies, heat exchangers, motors, agitators, etc., that may be used throughout a process control system to measure and/or control different aspects (e.g., other field devices and/or process control components) of the process control system. An example field device, such as a valve (e.g., a valve assembly, a fluid flow control assembly, etc.), may include both electrical and mechanical components. The valve may include electrical components such as a digital valve positioner, a flow rate sensor, a pressure sensor, a controller (e.g., a valve controller), etc. The valve may include mechanical components such as an actuator, a housing, a linkage, etc. In some examples, the field device may be a sensor (e.g., a pressure sensor, a temperature sensor, etc.) that monitors a condition or parameter of the valve, such as a pressure, a temperature, a level, vibrations, etc.

Avoiding equipment downtime, environmental incidents, and/or negative impacts on business depends on being able to detect changes in process variables and/or equipment conditions as they occur. Furthermore, being able to relate multiple measurements provides greater predictive value in assessing the likelihood of the onset of asset downtime as it provides a more complete picture of the condition of the asset. While in some examples, dashboards, user interfaces, display screens, etc., may be used to present statistics or other such operational characteristics of the process control system, users (e.g., operators, administrators, owners, clients, etc.) may desire different visualizations of presented data. Visualizations of such operational characteristics are costly and time-consuming to develop. For example, a client may need to contact a programmer of the process control system (e.g., via a “contact me” button on a user interface) to request a visualization and/or an update to a visualization. Creation of such visualizations may require a programmer to understand the requirements of the client, develop code (e.g., instructions, software stack, etc.) that can be executed to generate the visualizations to meet those requirements, and deploy the code to an environment of the client for operation.

Such an approach involves a significant financial investment in a software infrastructure to facilitate and fulfill requests from a client. Additionally, there is typically a delay between a client identifying a desired visualization, and such a visualization being presented to the client. During the delay, the asset data may have changed and the presented visualization may not be an accurate representation of the state of the asset, the state of the process control system, etc. Some previous implementations to provide real-time visualizations to clients include a web portal that facilitates client requests. However, web portals still involve financial and time investments for on premises installation for one client site (e.g., one factory), where a client may want visibility into multiple sites.

Examples disclosed herein utilize a cloud computing platform to monitor asset performance in a process control system. In particular, examples disclosed herein employ cloud templates (e.g., asset templates in the cloud) to execute instructions to monitor asset performance. Example cloud templates disclosed herein enable a customer to request and/or access asset performance analytics via a cloud computing platform with little to no programmer intervention (e.g., needing to wait for a programmer to write and execute sequences of programming commands). Examples disclosed herein provide a client with streamlined access to their asset analytics associated with multiple, distinct sites (e.g., different factories, different plants, etc.). As such, disclosed examples mitigate time delays between a client requesting visibility to asset performance and receiving such visibility because disclosed examples can be provisioned directly from a cloud marketplace (as opposed to vendor intervention). Moreover, disclosed examples enable a client to quickly view asset performance and enact remedial measures as appropriate to maintain equipment health and business health.

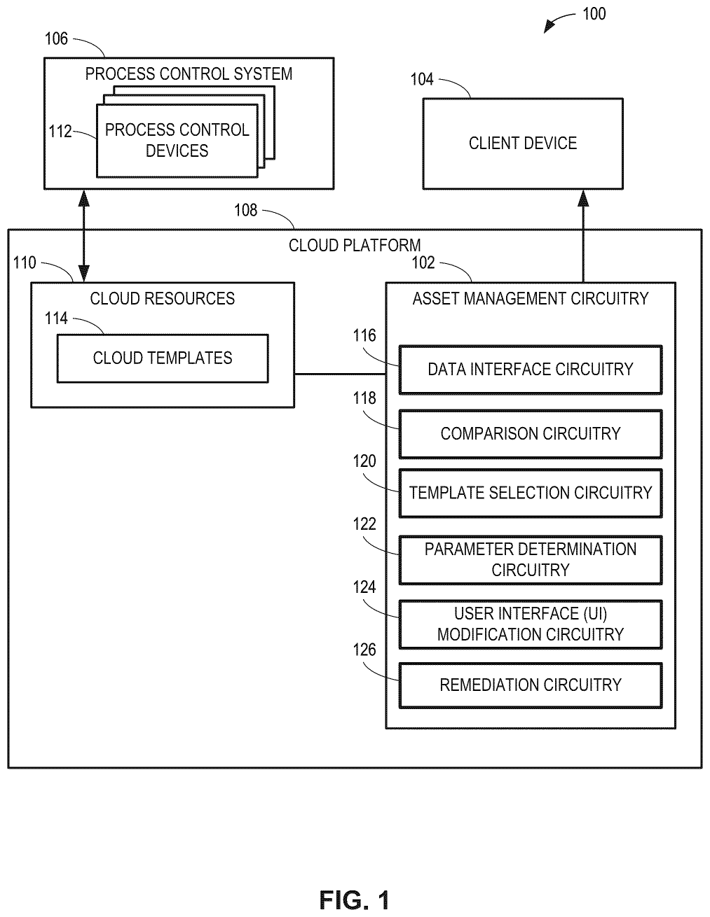

FIG. 1 is a block diagram of an example environment 100 in which example asset management circuitry 102 operates to provide an example client device 104 with asset health data. The example environment 100 includes the example client device 104, an example process control system 106, and an example cloud platform 108. The example cloud platform 108 hosts example cloud resources 110 that can monitor, manage, assess, etc., the process control system 106. The example process control system 106 can be associated with an example factory, plant floor, site, etc., monitored by the cloud platform 108. The example process control system 106 includes example process control devices 112 that are configured to interact with the cloud resources 110 provided by the cloud platform 108. The cloud platform 108 can be any infrastructure that enables the cloud resources 110 to be accessed and utilized by cloud capable devices (e.g., workstations in the process control system 106, the process control devices 112, the client device 104, etc.). In this example, the cloud platform 108 is a client cloud platform. In other examples, the cloud platform 108 may be managed by a publisher account (e.g., Emerson).

The example cloud platform 108 may employ the cloud resources 110 to access sensor data associated with at least one of the process control devices 112 in the process control system 106. The example cloud resources 110 include example cloud templates 114 having executable instructions to determine health parameters associated with the process control devices 112. For example, if a first one of the process control devices 112 is a valve, then at least one of the cloud templates 114 can include executable instructions to determine a health parameter associated with the valve. In turn, the example asset management circuitry 102 can modify and/or update the client device 104 (e.g., a user interface (UI) associated with the client device 104) to display the health parameters.

The example asset management circuitry 102 includes example data interface circuitry 116, example comparison circuitry 118, example template selection circuitry 120, example parameter determination circuitry 122, example UI modification circuitry 124, and example remediation circuitry 126. The asset management circuitry 102 of FIG. 1 may be instantiated (e.g., creating an instance of, bring into being for any length of time, materialize, implement, etc.) by programmable circuitry such as a Central Processor Unit (CPU) executing first instructions. Additionally or alternatively, the asset management circuitry 102 of FIG. 1 may be instantiated (e.g., creating an instance of, bring into being for any length of time, materialize, implement, etc.) by an Application Specific Integrated Circuit (ASIC) structured and/or configured in response to execution of second instructions to perform operations corresponding to the first instructions. It should be understood that some or all of the circuitry of FIG. 1 may, thus, be instantiated at the same or different times. Some or all of the circuitry of FIG. 1 may be instantiated, for example, in one or more threads executing concurrently on hardware and/or in series on hardware. Moreover, in some examples, some or all of the circuitry of FIG. 1 may be implemented by microprocessor circuitry executing instructions to implement one or more virtual machines and/or containers.

The example data interface circuitry 116 accesses, via at least one of the cloud resources 110, sensor data associated with a first one of the process control devices 112 operating in the process control system 106. In some examples, the sensor data associated with the first one of the process control devices 112 can indicate at least one of a speed of rotation associated with the first one of the process control devices 112, a temperature associated with the first one of the process control devices 112, or a flow rate associated with the first one of the process control devices 112. In some examples, the data interface circuitry 116 can access a request from the client device 104, wherein the request indicated which of the process control devices 112 to visualize.

The example comparison circuitry 118 compares the sensor data to a first example threshold parameter associated with the process control device. In some examples, the first threshold parameter may be at least one of a speed of rotation threshold, a temperature threshold, a flow rate threshold, a level threshold, a vibration threshold, etc. For example, a first example threshold parameter associated with a valve can be a maximum flow rate of 20.00 meters cubed per second (m³/s). In other examples, the comparison circuitry 118 can compare the health parameter to a second example threshold parameter. For example, the second threshold parameter may indicate a minimum health/performance of the process control device. In some examples, a health parameter that does not meet (e.g., does not satisfy, is less than, is outside of, etc.) the second threshold parameter may be indicative of detrimental effects to the process control device, the process control system 106, etc.

The example template selection circuitry 120 selects (e.g., determines, accesses, etc.) a first one of the cloud templates 114 based on a type of the first one of the process control devices 112. In some examples, the types of the process control devices 112 can include valves, pumps, tanks, sensors, etc. For example, if the first one of the process control devices 112 is a valve, then the template selection circuitry 120 selects at least one of the cloud templates 114 associated with valves.

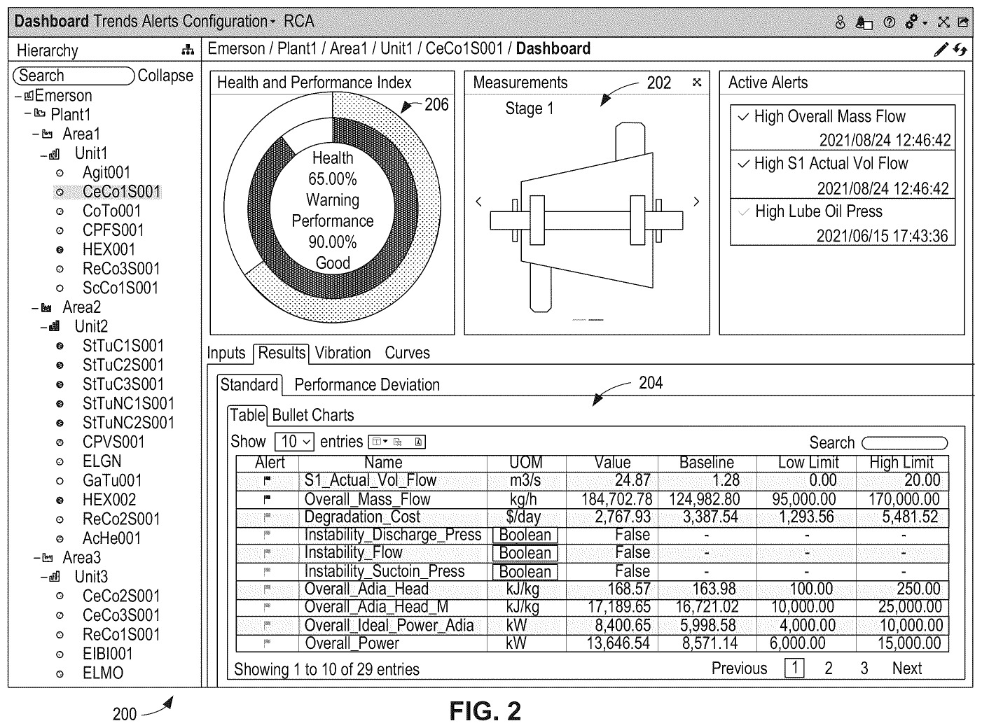

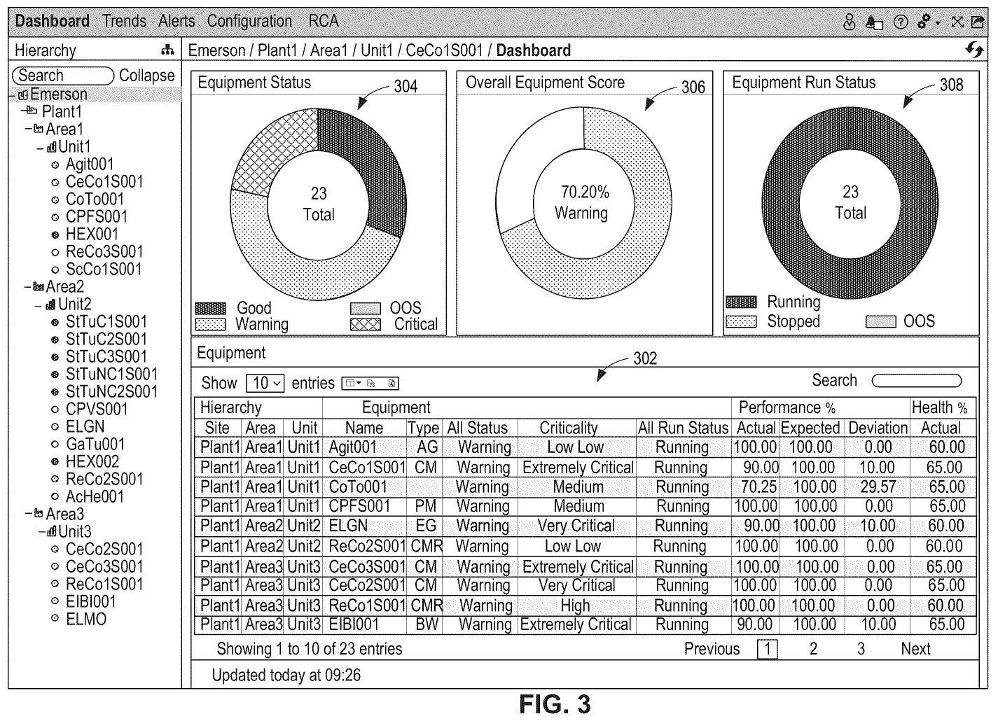

The example parameter determination circuitry 122 obtains, from the first one of the cloud templates 114 deployed in the cloud resources 110, a health parameter of the first one of the process control devices 112 based on the comparison. In some examples, the first one of the cloud templates 114 may access one or more of the values (e.g., sensor data, threshold parameter(s), etc.) from the visualizations described in connection with FIGS. 2 and 3. For example, if the sensor data indicates that the flow rate of the valve is 24.87 m³/s and the first threshold parameter indicates that the maximum flow rate is 20.00 m³/s, then the first one of the cloud templates 114 can determine that the health parameter is 65% (e.g., the valve is operating at 65% of its optimal operation (100%)). In some examples, the first one of the cloud templates 114 can generate a textual representation of the health parameter (e.g., “Good,” “Warning,” “Critical,” “Out of Service,” etc.). The first one of the cloud templates 114 may include domain knowledge for that particular asset to determine useful information (e.g., a health parameter) based on sensor data, asset specifications, etc. Further, the first one of the cloud templates 114 can utilize first principle calculations specific to the asset. In some examples, at least one of the cloud templates 114 can include instructions to generate an overall health of the process control system 106. Such an example one of the cloud templates 114 determine the overall health based on a health parameter associated with the first one of the process control devices 112, a second one of the process control devices 112, a third one of the process control devices 112, etc.

The example remediation circuitry 126 determines an example remedial action when the health parameter does not satisfy the second threshold parameter. In some examples, the first one of the process control devices 112 may be able to achieve sufficient performance when the health parameter is between 75%-100%. However, if the second threshold parameter is 75% and the health parameter is 65%, then the valve does not satisfy the second threshold parameter and the valve may not be able to achieve sufficient performance. In such examples, the remediation circuitry 126 can determine a remedial action to increase the health parameter to satisfy the second threshold parameter (e.g., 75%). As such, the remediation circuitry 126 can modify the first one of the process control devices 112 in order to modify the health parameter associated with the first one of the process control devices 112. In some examples, a remedial action may include updating, replacing, repairing, etc., the first one of the process control devices 112.

The example UI modification circuitry 124 displays the health parameter on the UI of the client device 104, the client device 104 accessing the cloud resources 110 (e.g., via the cloud platform 108). In some examples, the UI modification circuitry 124 can modify the UI of the client device 104 to display remedial actions determined by the remediation circuitry 126.

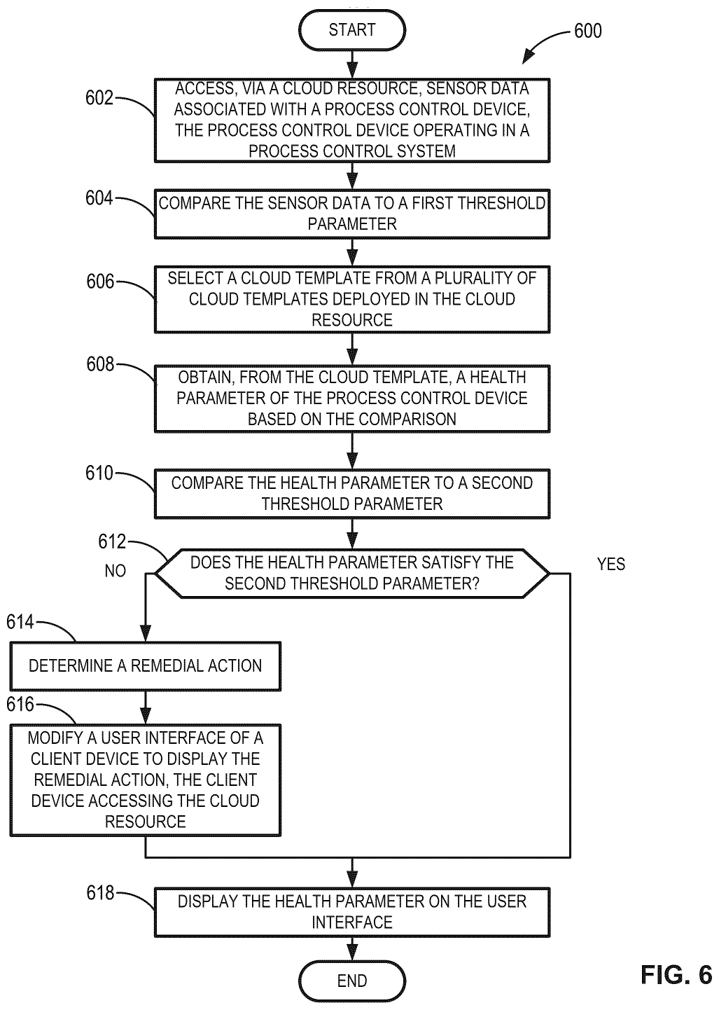

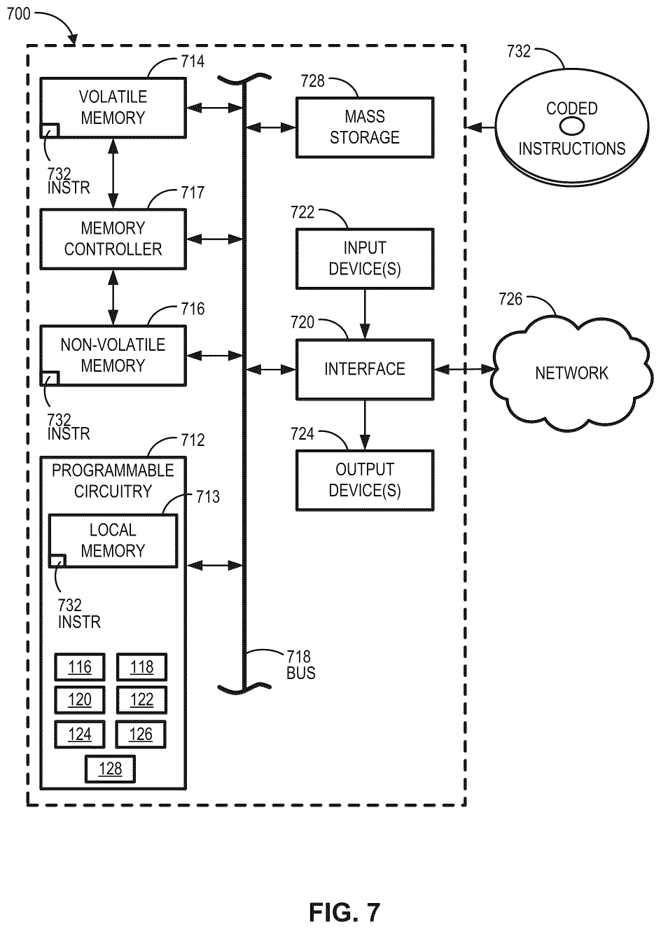

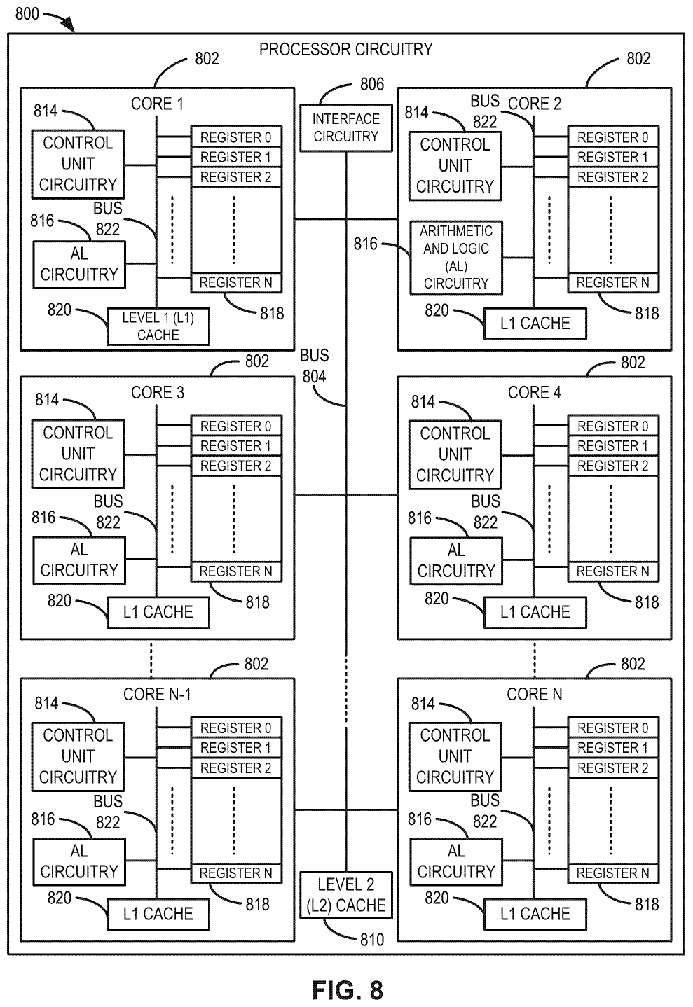

In some examples, the data interface circuitry 116 is instantiated by programmable circuitry executing data interfacing instructions and/or configured to perform operations such as those represented by the flowchart of FIG. 6. In some examples, the asset management circuitry 102 includes means for accessing sensor data. For example, the means for accessing may be implemented by the data interface circuitry 116. In some examples, the data interface circuitry 116 may be instantiated by programmable circuitry such as the example programmable circuitry 712 of FIG. 7. For instance, the data interface circuitry 116 may be instantiated by the example microprocessor 800 of FIG. 8 executing machine executable instructions such as those implemented by at least block 602 of FIG. 6. In some examples, the data interface circuitry 116 may be instantiated by hardware logic circuitry, which may be implemented by an ASIC or XPU configured and/or structured to perform operations corresponding to the machine readable instructions. Additionally or alternatively, the data interface circuitry 116 may be instantiated by any other combination of hardware, software, and/or firmware. For example, the data interface circuitry 116 may be implemented by at least one or more hardware circuits (e.g., processor circuitry, discrete and/or integrated analog and/or digital circuitry, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the comparison circuitry 118 is instantiated by programmable circuitry executing comparison instructions and/or configured to perform operations such as those represented by the flowchart of FIG. 6. In some examples, the asset management circuitry 102 includes means for comparing. For example, the means for comparing may be implemented by the comparison circuitry 118. In some examples, the comparison circuitry 118 may be instantiated by programmable circuitry such as the example programmable circuitry 712 of FIG. 7. For instance, the comparison circuitry 118 may be instantiated by the example microprocessor 800 of FIG. 8 executing machine executable instructions such as those implemented by at least blocks 604, 610, 612 of FIG. 6. In some examples, the comparison circuitry 118 may be instantiated by hardware logic circuitry, which may be implemented by an ASIC or XPU configured and/or structured to perform operations corresponding to the machine readable instructions. Additionally or alternatively, the comparison circuitry 118 may be instantiated by any other combination of hardware, software, and/or firmware. For example, the comparison circuitry 118 may be implemented by at least one or more hardware circuits (e.g., processor circuitry, discrete and/or integrated analog and/or digital circuitry, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the template selection circuitry 120 is instantiated by programmable circuitry executing template selection instructions and/or configured to perform operations such as those represented by the flowchart of FIG. 6. In some examples, the asset management circuitry 102 includes means for selecting a template. For example, the means for selecting may be implemented by the template selection circuitry 120. In some examples, the template selection circuitry 120 may be instantiated by programmable circuitry such as the example programmable circuitry 712 of FIG. 7. For instance, the template selection circuitry 120 may be instantiated by the example microprocessor 800 of FIG. 8 executing machine executable instructions such as those implemented by at least block 606 of FIG. 6. In some examples, the template selection circuitry 120 may be instantiated by hardware logic circuitry, which may be implemented by an ASIC or XPU configured and/or structured to perform operations corresponding to the machine readable instructions. Additionally or alternatively, the template selection circuitry 120 may be instantiated by any other combination of hardware, software, and/or firmware. For example, the template selection circuitry 120 may be implemented by at least one or more hardware circuits (e.g., processor circuitry, discrete and/or integrated analog and/or digital circuitry, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the parameter determination circuitry 122 is instantiated by programmable circuitry executing parameter determination instructions and/or configured to perform operations such as those represented by the flowchart of FIG. 6. In some examples, the asset management circuitry 102 includes means for determining a condition of a device. For example, the means for determining a parameter may be implemented by the parameter determination circuitry 122. In some examples, the parameter determination circuitry 122 may be instantiated by programmable circuitry such as the example programmable circuitry 712 of FIG. 7. For instance, the parameter determination circuitry 122 may be instantiated by the example microprocessor 800 of FIG. 8 executing machine executable instructions such as those implemented by at least block 608 of FIG. 6. In some examples, the parameter determination circuitry 122 may be instantiated by hardware logic circuitry, which may be implemented by an ASIC or XPU configured and/or structured to perform operations corresponding to the machine readable instructions. Additionally or alternatively, the parameter determination circuitry 122 may be instantiated by any other combination of hardware, software, and/or firmware. For example, the parameter determination circuitry 122 may be implemented by at least one or more hardware circuits (e.g., processor circuitry, discrete and/or integrated analog and/or digital circuitry, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the UI modification circuitry 124 is instantiated by programmable circuitry executing UI modification instructions and/or configured to perform operations such as those represented by the flowchart of FIG. 6. In some examples, the asset management circuitry 102 includes means for modifying a UI. For example, the means for modifying may be implemented by the UI modification circuitry 124. In some examples, the UI modification circuitry 124 may be instantiated by programmable circuitry such as the example programmable circuitry 712 of FIG. 7. For instance, the UI modification circuitry 124 may be instantiated by the example microprocessor 800 of FIG. 8 executing machine executable instructions such as those implemented by at least blocks 616, 618 of FIG. 6. In some examples, the UI modification circuitry 124 may be instantiated by hardware logic circuitry, which may be implemented by an ASIC or XPU configured and/or structured to perform operations corresponding to the machine readable instructions. Additionally or alternatively, the UI modification circuitry 124 may be instantiated by any other combination of hardware, software, and/or firmware. For example, the UI modification circuitry 124 may be implemented by at least one or more hardware circuits (e.g., processor circuitry, discrete and/or integrated analog and/or digital circuitry, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the remediation circuitry 126 is instantiated by programmable circuitry executing remediation instructions and/or configured to perform operations such as those represented by the flowchart of FIG. 6. In some examples, the asset management circuitry 102 includes means for determining a remedial action. For example, the means for determining may be implemented by the remediation circuitry 126. In some examples, the remediation circuitry 126 may be instantiated by programmable circuitry such as the example programmable circuitry 712 of FIG. 7. For instance, the remediation circuitry 126 may be instantiated by the example microprocessor 800 of FIG. 8 executing machine executable instructions such as those implemented by at least block 614 of FIG. 6. In some examples, the remediation circuitry 126 may be instantiated by hardware logic circuitry, which may be implemented by an ASIC or XPU configured and/or structured to perform operations corresponding to the machine readable instructions. Additionally or alternatively, the remediation circuitry 126 may be instantiated by any other combination of hardware, software, and/or firmware. For example, the remediation circuitry 126 may be implemented by at least one or more hardware circuits (e.g., processor circuitry, discrete and/or integrated analog and/or digital circuitry, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

FIGS. 2 and 3 include example visualizations 200, 300 generated by the example asset management circuitry 102 of FIG. 1. For example, the UI modification circuitry 124 can modify the UI of the client device 104 in FIG. 1 to display at least one of the visualizations 200, 300. Turning to FIG. 2, the example visualization 200 includes a graphical visualization 202 of an example valve. Further, the example visualization 200 includes textual representations 204 of the sensor data (e.g., 24.87 m³/s) and the threshold parameter (e.g., High Limit is 20.00 m³/s) associated with the valve. The example visualization 200 includes another graphical representation 206 of health parameters (e.g., 65% Health and 90% Performance) associated with the valve. In FIG. 3, the example visualization 300 includes textual representations 302 of the process control devices 112 (e.g., multiple process control devices 112) in the process control system 106. For example, the textual representations 302 can list the health parameters associated with each of the process control devices 112. Further, the example visualization 300 includes graphical representations 304, 306, 308 of the process control system 106.

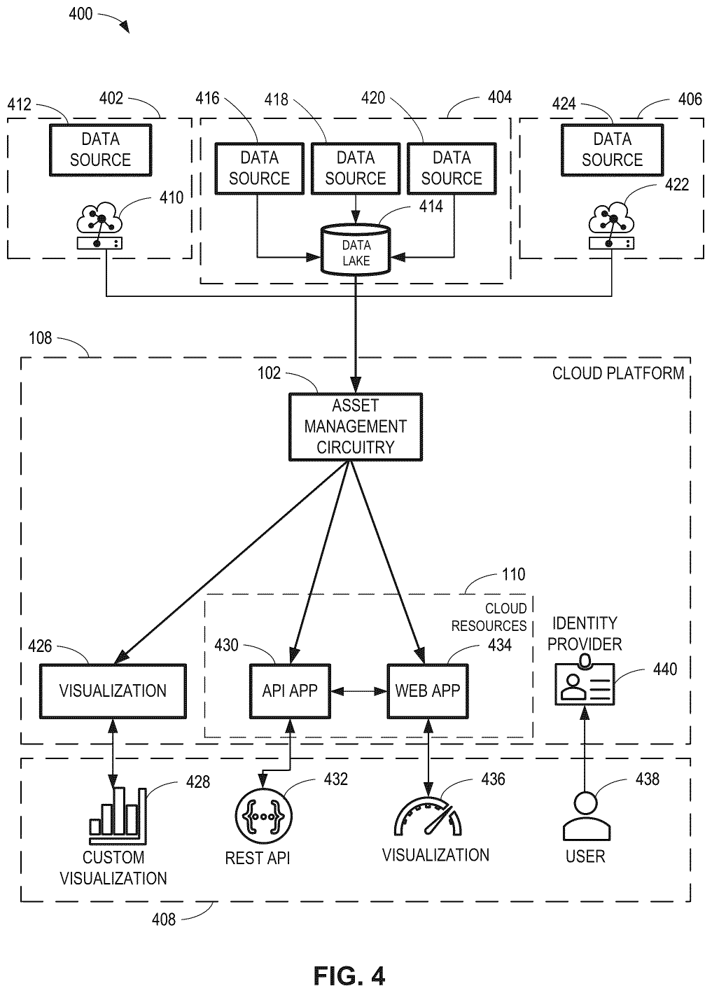

FIG. 4 illustrates another example environment 400 in which the asset management circuitry 102 of FIG. 1 operates to provide asset information to an example client. The example environment 400 includes the cloud platform 108, the asset management circuitry 102, the cloud resources 110, example process control systems 402, 404, 406, and an example client 408. In this example, each of the process control systems 402, 404, 406 represents a client plant that is geographically separated from the other plants. The example process control system 402 includes an example data publisher 410 that publishes (e.g., transmits, uploads, etc.) data from an example data source 412 associated with the process control system 402 to the asset management circuitry 102. The example process control system 404 includes an example data lake 414 that stores data from example data sources 416, 418, 420 associated with the process control system 404 and publishes the data to the asset management circuitry 102. The example process control system 406 includes an example data publisher 422 that publishes data from an example data source 424 associated with the process control system 406 to the asset management circuitry 102. The example data sources 412, 416, 418, 420, 424 can include sensor data gathered from process control devices operating in each of the process control systems 402, 404, 406.

The example asset management circuitry 102 can generate an example visualization 426 (e.g., the visualization 200, the visualization 300, etc.) based on the sensor data associated with at least one of the process control systems 402, 404, 406. For example, the client 408 may request an example custom visualization 428 (e.g., a modification to the visualization 426). In other examples, the asset management circuitry 102 can generate an example Application Programming Interface Application (API APP) 430 to capture the visualization(s) of the process control systems 402, 404, 406. The example client 408 can access the API APP 430 from a Representation State Transfer (REST) API 432. Additionally or alternatively, the example asset management circuitry 102 can generate an example WEB APP 434 to capture the visualization(s) of at least one of the process control systems 402, 404, 406. The example client 408 can access an example visualization 436 of the at least one of the process control systems 402, 404, 406 from the WEB APP 434. As shown in FIG. 4, the API APP 430 and the WEB APP 434 may be hosted by the cloud resources 110. In some examples, the cloud platform 108 can verify the client 408 (e.g., an example user 438 of the client device 104 in FIG. 1) via an example identity provider 440 (e.g., login credentials, access codes, etc.). Thus, the example cloud platform 108 can ensure that the client 408 can access sensitive or otherwise confidential information associated with the process control systems 402, 404, 406.

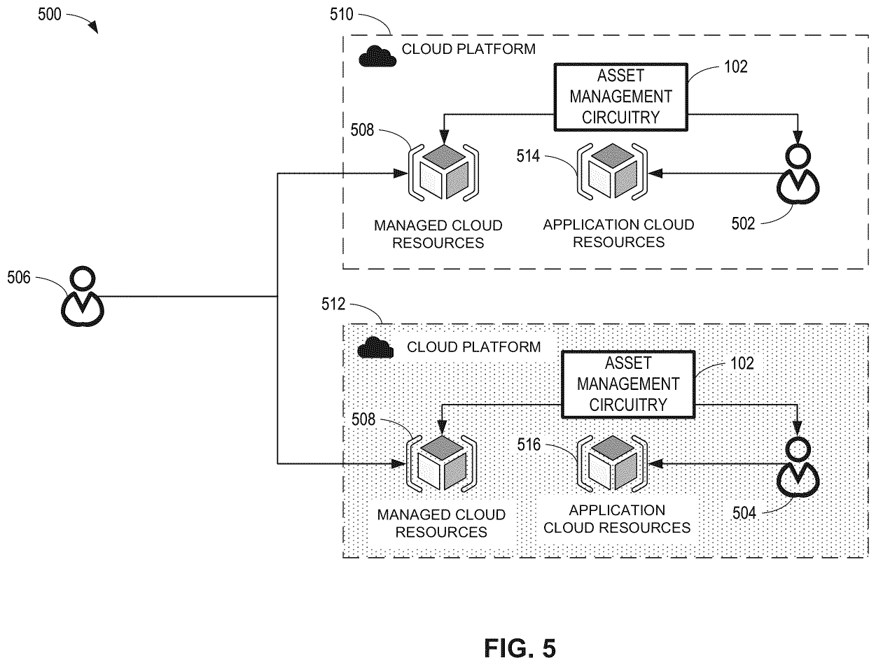

FIG. 5 illustrates an example multi-client environment 500 in which the example asset management circuitry 102 operates to manage the communication of the example clients 502, 504 with an example data publisher 506 (e.g., Emerson). The example data publisher 506 has access to example managed cloud resources 508 that encompass data (e.g., sensor data, health parameters, parameter thresholds, etc.) for each of the clients (e.g., example client platform 510, example client platform 512, etc.) that subscribe to the data publisher 506. However, the example client platforms 510, 512 have respective example application cloud resources 514, 516 separate from the managed cloud resources 508. The example client platform 510 hosts the application cloud resources 514 that monitor, manage, assess, etc., process control system(s) associated with the client 502. Similarly, the second example client platform 512 hosts the application cloud resources 516 that monitor, manage, assess, etc., process control system(s) associated with the client 504.

The example client 502 (e.g., a client account) may have full access to the corresponding application cloud resources 514 and partial (e.g., limited, filtered, etc.) access to the managed cloud resources 508. As such, the example client 502 can communicate with the data publisher 506 to request diagnostics and/or other asset information from the managed cloud resources 508. In other examples, the client 502 can grant and/or deny the data publisher 506 permission to analyze any of the process control systems associated with the client 502 and provide diagnostic and/or other asset information (e.g., health parameters, visualizations, remedial actions, etc.). As such, the example data publisher 506 can provide on demand (e.g., real time, immediate, etc.) diagnostics to the example client 502. As shown in the example of FIG. 5, the example asset management circuitry 102 can manage (e.g., monitor, facilitate, etc.) such communications between the data publisher 506 and the client 502.

Similarly, the example client 504 can communicate with the data publisher 506 to request diagnostics and/or other asset information from the managed cloud resources 508. In other examples, the client 504 can grant and/or deny the data publisher 506 permission to analyze any of the process control systems associated with the client 504 and provide diagnostic and/or other asset information (e.g., health parameters, visualizations, remedial actions, etc.). As such, the example data publisher 506 can provide on demand diagnostics to the example client 504. As shown in the example of FIG. 5, the example asset management circuitry 102 can manage such communications between the data publisher 506 and the client 504.

While an example manner of implementing the asset management circuitry 102 of FIG. 1 is illustrated in FIG. 1, one or more of the elements, processes, and/or devices illustrated in FIG. 1 may be combined, divided, re-arranged, omitted, eliminated, and/or implemented in any other way. Further, the example data interface circuitry 116, the example comparison circuitry 118, the example template selection circuitry 120, the example parameter determination circuitry 122, the example UI modification circuitry 124, the example remediation circuitry 126, and/or, more generally, the example asset management circuitry 102 of FIG. 1, may be implemented by hardware alone or by hardware in combination with software and/or firmware. Thus, for example, any of the example data interface circuitry 116, the example comparison circuitry 118, the example template selection circuitry 120, the example parameter determination circuitry 122, the example UI modification circuitry 124, the example remediation circuitry 126 and/or, more generally, the example asset management circuitry 102, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), and/or programmable logic device(s) (PLD(s)). Further still, the example asset management circuitry 102 of FIG. 1 may include one or more elements, processes, and/or devices in addition to, or instead of, those illustrated in FIG. 1, and/or may include more than one of any or all of the illustrated elements, processes and devices.

An example flowchart representative of example machine readable instructions, which may be executed by programmable circuitry to implement and/or instantiate the asset management circuitry 102 of FIG. 1 and/or representative of example operations which may be performed by programmable circuitry to implement and/or instantiate the asset management circuitry 102 of FIG. 1, are shown in FIG. 6. The machine readable instructions may be one or more executable programs or portion(s) of one or more executable programs for execution by programmable circuitry such as the programmable circuitry 712 shown in the example programmable circuitry platform 700 discussed below in connection with FIG. 7 and/or may be one or more function(s) or portion(s) of functions to be performed by example programmable circuitry. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart illustrated in FIG. 6, many other methods of implementing the example asset management circuitry 102 may alternatively be used. For example, the order of execution of the blocks of the flowchart may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an API, etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIG. 6 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 6 is a flowchart representative of example machine readable instructions and/or example operations 600 that may be executed, instantiated, and/or performed by programmable circuitry to modify an example UI of the client device 104. The example machine-readable instructions and/or the example operations 600 of FIG. 6 begin at block 602, at which the example data interface circuitry 116 accesses, via a cloud resource (e.g., at least one of the cloud resources 110), sensor data associated with a process control device (e.g., a first one of the process control devices 112), the process control device operating in the process control system 106. In some examples, the sensor data associated with the first one of the process control devices 112 can, for example, indicate at least one of a speed of rotation associated with the first one of the process control devices 112, a temperature associated with the first one of the process control devices 112, or a flow rate associated with the first one of the process control devices 112. In some examples, the data interface circuitry 116 can access a request from the client device 104, where the request indicates which of the process control devices 112 to visualize.

At block 604, the example comparison circuitry 118 compares the sensor data to a first example threshold parameter (e.g., associated with the first one of the process control devices 112). In some examples, the first threshold parameter may be at least one of a speed of rotation threshold, a temperature threshold, a flow rate threshold, etc. For example, a first example threshold parameter associated with a valve can be a maximum flow rate of 20.00 m³/s.

At block 606, the example template selection circuitry 120 selects a cloud template from the plurality of cloud templates 114 deployed in the cloud resource(s) 110. For example, the template selection circuitry 120 selects a first one of the cloud templates 114 based on a type of the first one of the process control devices 112. In some examples, the types of the process control devices 112 can include valves, pumps, tanks, sensors, etc. If the first one of the process control devices 112 is a valve, then the template selection circuitry 120 selects at least one of the cloud templates 114 associated with valves.

At block 608, the example parameter determination circuitry 122 obtains, from the first one of the cloud templates 114, a health parameter of the first one of the process control devices 112 based on the comparison. For example, if the sensor data indicates that the flow rate of the valve is 24.87 m³/s and the first threshold parameter indicates that the maximum flow rate is 20.00 m³/s, then the first one of the cloud templates 114 can determine that the health parameter is 65%. In other examples, the first one of the cloud templates 114 may utilize one or more of the values in at least one of the visualization 200 (FIG. 2) or the visualization 300 (FIG. 3) to determine the health parameter.

At block 610, the example comparison circuitry 118 compares the health parameter to a second example threshold parameter. For example, the second threshold parameter may indicate a minimum health/performance of the first one of the process control devices 112, beyond which the first one of the process control devices 112 may be indicative to detrimental effects (e.g., due to excessive flow) to the process control system 106.

At block 612, the example comparison circuitry 118 determines whether the health parameter satisfies the second threshold parameter. If the example health parameter does not satisfy the second threshold parameter, then the process proceeds to block 614. For example, if the health parameter is 65% and the second threshold parameter is 75%, then the comparison circuitry 118 can determine that the health parameter does not satisfy the second threshold parameter (e.g., 65%<75%). In other words, the comparison circuitry 118 can determine that the valve does not meet the allowable health range (e.g., 75%-100%) and may not be able to achieve sufficient performance. In such examples, the process proceeds to block 614. Alternatively, if the example health parameter satisfies the second threshold parameter, then the process proceeds to block 618. For example, if the health parameter is 95% and the second threshold parameter is 75%, then the comparison circuitry 118 can determine that the health parameter satisfies the second threshold parameter (e.g., 95%>75%). In other words, the comparison circuitry 118 can determine that the valve is within the allowable health range (e.g., 75%-100%) and may be able to achieve sufficient performance (e.g., even though 95%<100%). In such examples, the process proceeds to block 618.

At block 614, the example remediation circuitry 126 determines an example remedial action. For example, the remediation circuitry 126 can determine a remedial action to increase the health parameter to satisfy the second threshold parameter (e.g., 75%). As such, the remediation circuitry 126 can modify the first one of the process control devices 112 to modify the health parameter associated with the first one of the process control devices 112. In some examples, a remedial action may include updating, replacing, repairing, etc., the first one of the process control devices 112.

At block 616, the example UI modification circuitry 124 modifies a UI of the client device 104 to display the remedial action, the client device 104 accessing the cloud resource(s) 110.

At block 618, the example UI modification circuitry 124 displays the health parameter on the UI of the client device 104. Then, the process ends.

FIG. 7 is a block diagram of an example programmable circuitry platform 700 structured to execute and/or instantiate the example machine-readable instructions and/or the example operations of FIG. 6 to implement the asset management circuitry 102 of FIG. 1. The programmable circuitry platform 700 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 700 of the illustrated example includes programmable circuitry 712. The programmable circuitry 712 of the illustrated example is hardware. For example, the programmable circuitry 712 can be implemented by one or more integrated circuits, logic circuits, microprocessors, CPUs, GPUs, DSPs, and/or microcontrollers from any desired family or manufacturer. The programmable circuitry 712 may be implemented by one or more semiconductor based (e.g., silicon based) devices. In this example, the programmable circuitry 712 implements the example data interface circuitry 116, the example comparison circuitry 118, the example template selection circuitry 120, the example parameter determination circuitry 122, the example UI modification circuitry 124, and the example remediation circuitry 126.

The programmable circuitry 712 of the illustrated example includes a local memory 713 (e.g., a cache, registers, etc.). The programmable circuitry 712 of the illustrated example is in communication with main memory 714, 716, which includes a volatile memory 714 and a non-volatile memory 716, by a bus 718. The volatile memory 714 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 716 may be implemented by flash memory and/or any other desired type of memory device. Access to the main memory 714, 716 of the illustrated example is controlled by a memory controller 717. In some examples, the memory controller 717 may be implemented by one or more integrated circuits, logic circuits, microcontrollers from any desired family or manufacturer, or any other type of circuitry to manage the flow of data going to and from the main memory 714, 716.

The programmable circuitry platform 700 of the illustrated example also includes interface circuitry 720. The interface circuitry 720 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 722 are connected to the interface circuitry 720. The input device(s) 722 permit(s) a user (e.g., a human user, a machine user, etc.) to enter data and/or commands into the programmable circuitry 712. The input device(s) 722 can be implemented by, for example, an audio sensor, a microphone, a camera (still or video), a keyboard, a button, a mouse, a touchscreen, a trackpad, a trackball, an isopoint device, and/or a voice recognition system.

One or more output devices 724 are also connected to the interface circuitry 720 of the illustrated example. The output device(s) 724 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 720 of the illustrated example, thus, typically includes a graphics driver card, a graphics driver chip, and/or graphics processor circuitry such as a GPU.

The interface circuitry 720 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 726. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 700 of the illustrated example also includes one or more mass storage discs or devices 728 to store firmware, software, and/or data. Examples of such mass storage discs or devices 728 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 732, which may be implemented by the machine readable instructions of FIG. 6, may be stored in the mass storage device 728, in the volatile memory 714, in the non-volatile memory 716, and/or on at least one non-transitory computer readable storage medium such as a CD or DVD which may be removable.

FIG. 8 is a block diagram of an example implementation of the programmable circuitry 712 of FIG. 7. In this example, the programmable circuitry 712 of FIG. 7 is implemented by a microprocessor 800. For example, the microprocessor 800 may be a general-purpose microprocessor (e.g., general-purpose microprocessor circuitry). The microprocessor 800 executes some or all of the machine-readable instructions of the flowchart of FIG. 6 to effectively instantiate the circuitry of FIG. 1 as logic circuits to perform operations corresponding to those machine readable instructions. In some such examples, the circuitry of FIG. 1 is instantiated by the hardware circuits of the microprocessor 800 in combination with the machine-readable instructions. For example, the microprocessor 800 may be implemented by multi-core hardware circuitry such as a CPU, a DSP, a GPU, an XPU, etc. Although it may include any number of example cores 802 (e.g., 1 core), the microprocessor 800 of this example is a multi-core semiconductor device including N cores. The cores 802 of the microprocessor 800 may operate independently or may cooperate to execute machine readable instructions. For example, machine code corresponding to a firmware program, an embedded software program, or a software program may be executed by one of the cores 802 or may be executed by multiple ones of the cores 802 at the same or different times. In some examples, the machine code corresponding to the firmware program, the embedded software program, or the software program is split into threads and executed in parallel by two or more of the cores 802. The software program may correspond to a portion or all of the machine readable instructions and/or operations represented by the flowchart of FIG. 6.

The cores 802 may communicate by a first example bus 804. In some examples, the first bus 804 may be implemented by a communication bus to effectuate communication associated with one(s) of the cores 802. For example, the first bus 804 may be implemented by at least one of an Inter-Integrated Circuit (I2C) bus, a Serial Peripheral Interface (SPI) bus, a PCI bus, or a PCIe bus. Additionally or alternatively, the first bus 804 may be implemented by any other type of computing or electrical bus. The cores 802 may obtain data, instructions, and/or signals from one or more external devices by example interface circuitry 806. The cores 802 may output data, instructions, and/or signals to the one or more external devices by the interface circuitry 806. Although the cores 802 of this example include example local memory 820 (e.g., Level 1 (L1) cache that may be split into an L1 data cache and an L1 instruction cache), the microprocessor 800 also includes example shared memory 810 that may be shared by the cores (e.g., Level 2 (L2 cache)) for high-speed access to data and/or instructions. Data and/or instructions may be transferred (e.g., shared) by writing to and/or reading from the shared memory 810. The local memory 820 of each of the cores 802 and the shared memory 810 may be part of a hierarchy of storage devices including multiple levels of cache memory and the main memory (e.g., the main memory 714, 716 of FIG. 7). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 802 may be referred to as a CPU, DSP, GPU, etc., or any other type of hardware circuitry. Each core 802 includes control unit circuitry 814, arithmetic and logic (AL) circuitry (sometimes referred to as an ALU) 816, a plurality of registers 818, the local memory 820, and a second example bus 822. Other structures may be present. For example, each core 802 may include vector unit circuitry, single instruction multiple data (SIMD) unit circuitry, load/store unit (LSU) circuitry, branch/jump unit circuitry, floating-point unit (FPU) circuitry, etc. The control unit circuitry 814 includes semiconductor-based circuits structured to control (e.g., coordinate) data movement within the corresponding core 802. The AL circuitry 816 includes semiconductor-based circuits structured to perform one or more mathematic and/or logic operations on the data within the corresponding core 802. The AL circuitry 816 of some examples performs integer based operations. In other examples, the AL circuitry 816 also performs floating-point operations. In yet other examples, the AL circuitry 816 may include first AL circuitry that performs integer-based operations and second AL circuitry that performs floating-point operations. In some examples, the AL circuitry 816 may be referred to as an Arithmetic Logic Unit (ALU).

The registers 818 are semiconductor-based structures to store data and/or instructions such as results of one or more of the operations performed by the AL circuitry 816 of the corresponding core 802. For example, the registers 818 may include vector register(s), SIMD register(s), general-purpose register(s), flag register(s), segment register(s), machine-specific register(s), instruction pointer register(s), control register(s), debug register(s), memory management register(s), machine check register(s), etc. The registers 818 may be arranged in a bank as shown in FIG. 8. Alternatively, the registers 818 may be organized in any other arrangement, format, or structure, such as by being distributed throughout the core 802 to shorten access time. The second bus 822 may be implemented by at least one of an I2C bus, a SPI bus, a PCI bus, or a PCIe bus.

Each core 802 and/or, more generally, the microprocessor 800 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 800 is a semiconductor device fabricated to include many transistors interconnected to implement the structures described above in one or more integrated circuits (ICs) contained in one or more packages.

The microprocessor 800 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs such as those discussed herein. A GPU, DSP and/or other programmable device can also be an accelerator. Accelerators may be on-board the microprocessor 800, in the same chip package as the microprocessor 800 and/or in one or more separate packages from the microprocessor 800.

Although FIG. 8 illustrates one example implementation of the programmable circuitry 712 of FIG. 7, many other approaches are contemplated. In some such hybrid examples, one or more cores 802 of FIG. 8 may execute a first portion of the machine readable instructions represented by the flowchart of FIG. 6 to perform first operation(s)/function(s), an ASIC may be configured and/or structured to perform second operation(s)/function(s) corresponding to a second portion of the machine readable instructions represented by the flowchart of FIG. 6.

It should be understood that some or all of the circuitry of FIG. 1 may, thus, be instantiated at the same or different times. For example, same and/or different portion(s) of the microprocessor 800 of FIG. 8 may be programmed to execute portion(s) of machine-readable instructions at the same and/or different times. In some examples, same and/or different portion(s) of the microprocessor 800 of FIG. 8 may be configured and/or structured to perform operations/functions corresponding to portion(s) of machine-readable instructions at the same and/or different times.

In some examples, some or all of the circuitry of FIG. 1 may be instantiated, for example, in one or more threads executing concurrently and/or in series. For example, the microprocessor 800 of FIG. 8 may execute machine readable instructions in one or more threads executing concurrently and/or in series. Moreover, in some examples, some or all of the circuitry of FIG. 1 may be implemented within one or more virtual machines and/or containers executing on the microprocessor 800 of FIG. 8.

In some examples, the programmable circuitry 712 of FIG. 7 may be in one or more packages. For example, the microprocessor 800 of FIG. 8 may be in one or more packages. In some examples, an XPU may be implemented by the programmable circuitry 712 of FIG. 7, which may be in one or more packages. For example, the XPU may include a CPU (e.g., the microprocessor 800 of FIG. 8) in one package, a DSP in another package, and a GPU in yet another package.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that employ cloud templates to execute instructions to monitor asset performance. Disclosed systems, apparatus, articles of manufacture, and methods improve the efficiency of using a computing device by enable a customer to request and/or access asset performance analytics via a cloud computing platform with little to no programmer intervention (e.g., needing to wait for a programmer to write and execute sequences of programming commands). Examples disclosed herein provide a client with streamlined access to their asset analytics associated with multiple, distinct sites. As such, disclosed examples mitigate time delays between a client requesting visibility to asset performance and receiving such visibility. Moreover, disclosed examples enable a client to quickly view asset performance and enact remedial measures as appropriate to maintain equipment health and business health. Disclosed systems, apparatus, articles of manufacture, and methods are accordingly directed to one or more improvement(s) in the operation of a machine such as a computer or other electronic and/or mechanical device.

Example 1 includes an apparatus comprising interface circuitry, machine-readable instructions, and at least one processor circuit to be programmed by the machine-readable instructions to access, via a cloud resource, sensor data associated with a process control device operating in a process control system, compare the sensor data to a threshold parameter associated with the process control device, obtain, from a cloud template deployed in the cloud resource, a health parameter of the process control device based on the comparison, and display the health parameter on a user interface of a computing device, the computing device accessing the cloud resource.

Example 2 includes the apparatus of example 1, wherein the machine-readable instructions, when executed or instantiated by one or more of the at least one processor circuit, cause the one or more of the at least one processor circuit to select the cloud template from a plurality of cloud templates based on a type of the process control device.

Example 3 includes the apparatus of example 2, wherein the type of the process control device includes at least one of a valve, a pump, or a tank.

Example 4 includes the apparatus of example 1, wherein the sensor data indicates at least one of a speed of rotation associated with the process control device, a temperature associated with the process control device, or a flow rate associated with the process control device.

Example 5 includes the apparatus of example 4, wherein the threshold parameter is at least one of a speed of rotation threshold, a temperature threshold, or a flow rate threshold.

Example 6 includes the apparatus of example 1, wherein the threshold parameter is a first threshold parameter, wherein the machine-readable instructions, when executed or instantiated by one or more of the at least one processor circuit, cause the one or more of the at least one processor circuit to compare the health parameter to a second threshold parameter, and determine a remedial action when the health parameter is less than the second threshold parameter, the remedial action to modify the health parameter.

Example 7 includes the apparatus of example 6, wherein the machine-readable instructions, when executed or instantiated by one or more of the at least one processor circuit, cause the one or more of the at least one processor circuit to modify the user interface to display the remedial action.

Example 8 includes a non-transitory machine-readable storage medium comprising instructions to cause programmable circuitry to at least access, via a cloud resource, sensor data associated with a process control device operating in a process control system, compare the sensor data to a threshold parameter associated with the process control device, obtain, from a cloud template deployed in the cloud resource, a health parameter of the process control device based on the comparison, and display the health parameter on a user interface of a computing device, the computing device accessing the cloud resource.

Example 9 includes the non-transitory machine-readable storage medium of example 8, wherein the instructions, when executed or instantiated by the programmable circuitry, further cause the programmable circuitry to select the cloud template from a plurality of cloud templates based on a type of the process control device.

Example 10 includes the non-transitory machine-readable storage medium of example 9, wherein the type of the process control device includes at least one of a valve, a pump, or a tank.

Example 11 includes the non-transitory machine-readable storage medium of example 8, wherein the sensor data indicates at least one of a speed of rotation associated with the process control device, a temperature associated with the process control device, or a flow rate associated with the process control device.

Example 12 includes the non-transitory machine-readable storage medium of example 11, wherein the threshold parameter is at least one of a speed of rotation threshold, a temperature threshold, or a flow rate threshold.

Example 13 includes the non-transitory machine-readable storage medium of example 8, wherein the threshold parameter is a first threshold parameter, wherein the instructions, when executed or instantiated by the programmable circuitry, further cause the programmable circuitry to compare the health parameter to a second threshold parameter, and determine a remedial action when the health parameter is less than the second threshold parameter, the remedial action to modify the health parameter.

Example 14 includes the non-transitory machine-readable storage medium of example 13, wherein the instructions, when executed or instantiated by the programmable circuitry, further cause the programmable circuitry to display the remedial action.

Example 15 includes a method comprising accessing, by at least one processor circuit programmed by at least one instruction, via a cloud resource, sensor data associated with a process control device operating in a process control system, comparing, by one or more of the at least one processor circuit, the sensor data to a threshold parameter associated with the process control device, obtaining, by one or more of the at least one processor circuit, from a cloud template deployed in the cloud resource, a health parameter of the process control device based on the comparison, and displaying, by one or more of the at least one processor circuit, the health parameter on a user interface of a computing device, the computing device accessing the cloud resource.

Example 16 includes the method of example 15, further including selecting the cloud template from a plurality of cloud templates based on a type of the process control device.

Example 17 includes the method of example 16, wherein the type of the process control device includes at least one of a valve, a pump, or a tank.

Example 18 includes the method of example 15, wherein the sensor data indicates at least one of a speed of rotation associated with the process control device, a temperature associated with the process control device, or a flow rate associated with the process control device.

Example 19 includes the method of example 18, wherein the threshold parameter is at least one of a speed of rotation threshold, a temperature threshold, or a flow rate threshold.

Example 20 includes the method of example 15, wherein the threshold parameter is a first threshold parameter, further including comparing the health parameter to a second threshold parameter, and determining a remedial action when the health parameter is less than the second threshold parameter, the remedial action to modify the health parameter.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus comprising:
interface circuitry;
machine-readable instructions; and
at least one processor circuit to be programmed by the machine-readable instructions to:
access, via a cloud resource, sensor data associated with a process control device operating in a process control system;
compare the sensor data to a threshold parameter associated with the process control device;
obtain, from a cloud template deployed in the cloud resource, a health parameter of the process control device based on the comparison; and
display the health parameter on a user interface of a computing device, the computing device accessing the cloud resource.

2. The apparatus of claim 1, wherein the machine-readable instructions, when executed or instantiated by one or more of the at least one processor circuit, cause the one or more of the at least one processor circuit to select the cloud template from a plurality of cloud templates based on a type of the process control device.

3. The apparatus of claim 2, wherein the type of the process control device includes at least one of a valve, a pump, or a tank.

4. The apparatus of claim 1, wherein the sensor data indicates at least one of a speed of rotation associated with the process control device, a temperature associated with the process control device, or a flow rate associated with the process control device.

5. The apparatus of claim 4, wherein the threshold parameter is at least one of a speed of rotation threshold, a temperature threshold, or a flow rate threshold.

6. The apparatus of claim 1, wherein the threshold parameter is a first threshold parameter, wherein the machine-readable instructions, when executed or instantiated by one or more of the at least one processor circuit, cause the one or more of the at least one processor circuit to:
compare the health parameter to a second threshold parameter; and
determine a remedial action when the health parameter is less than the second threshold parameter, the remedial action to modify the health parameter.

7. The apparatus of claim 6, wherein the machine-readable instructions, when executed or instantiated by one or more of the at least one processor circuit, cause the one or more of the at least one processor circuit to modify the user interface to display the remedial action.

8. A non-transitory machine-readable storage medium comprising instructions to cause programmable circuitry to at least:
access, via a cloud resource, sensor data associated with a process control device operating in a process control system;
compare the sensor data to a threshold parameter associated with the process control device;
obtain, from a cloud template deployed in the cloud resource, a health parameter of the process control device based on the comparison; and
display the health parameter on a user interface of a computing device, the computing device accessing the cloud resource.

9. The non-transitory machine-readable storage medium of claim 8, wherein the instructions, when executed or instantiated by the programmable circuitry, further cause the programmable circuitry to select the cloud template from a plurality of cloud templates based on a type of the process control device.

10. The non-transitory machine-readable storage medium of claim 9, wherein the type of the process control device includes at least one of a valve, a pump, or a tank.

11. The non-transitory machine-readable storage medium of claim 8, wherein the sensor data indicates at least one of a speed of rotation associated with the process control device, a temperature associated with the process control device, or a flow rate associated with the process control device.

12. The non-transitory machine-readable storage medium of claim 11, wherein the threshold parameter is at least one of a speed of rotation threshold, a temperature threshold, or a flow rate threshold.

13. The non-transitory machine-readable storage medium of claim 8, wherein the threshold parameter is a first threshold parameter, wherein the instructions, when executed or instantiated by the programmable circuitry, further cause the programmable circuitry to:
compare the health parameter to a second threshold parameter; and
determine a remedial action when the health parameter is less than the second threshold parameter, the remedial action to modify the health parameter.

14. The non-transitory machine-readable storage medium of claim 13, wherein the instructions, when executed or instantiated by the programmable circuitry, further cause the programmable circuitry to display the remedial action.

15. A method comprising:
accessing, by at least one processor circuit programmed by at least one instruction, via a cloud resource, sensor data associated with a process control device operating in a process control system;
comparing, by one or more of the at least one processor circuit, the sensor data to a threshold parameter associated with the process control device;
obtaining, by one or more of the at least one processor circuit, from a cloud template deployed in the cloud resource, a health parameter of the process control device based on the comparison; and
displaying, by one or more of the at least one processor circuit, the health parameter on a user interface of a computing device, the computing device accessing the cloud resource.

16. The method of claim 15, further including selecting the cloud template from a plurality of cloud templates based on a type of the process control device.

17. The method of claim 16, wherein the type of the process control device includes at least one of a valve, a pump, or a tank.

18. The method of claim 15, wherein the sensor data indicates at least one of a speed of rotation associated with the process control device, a temperature associated with the process control device, or a flow rate associated with the process control device.

19. The method of claim 18, wherein the threshold parameter is at least one of a speed of rotation threshold, a temperature threshold, or a flow rate threshold.

20. The method of claim 15, wherein the threshold parameter is a first threshold parameter, further including:
comparing the health parameter to a second threshold parameter; and
determining a remedial action when the health parameter is less than the second threshold parameter, the remedial action to modify the health parameter.
